(19) United States
(12) Patent Application Publication
(10) Pub. No.: US 2010/0183840 A1
(43) Pub. Date: Jul. 22, 2010

(54) MOLDED SIDING HAVING LONGITUDINALLY-ORIENTED REINFORCEMENT FIBERS, AND SYSTEM AND METHOD FOR MAKING THE SAME

(75) Inventors: John Richard Logan, Oxford, MI (US); Thomas J. Baker, Dryden, MI (US)

Correspondence Address: HOWARD & HOWARD ATTORNEYS PLLC, 450 West Fourth Street, Royal Oak, MI, 48067, US

(73) Assignee: TAPCO INTERNATIONAL CORPORATION, Wixom, MI (US)

(21) Appl. No.: 12/689,368

(22) Filed: Jan. 19, 2010

Related U.S. Application Data
(60) Provisional application No. 61/145,592, filed on Jan. 19, 2009.

(51) Int. Cl. B28B 23/00; E04C 2/00; E04C 2/34; E04C 2/06; B28B 23/04

(52) U.S. Cl. 428/114; 52/554; 52/794.1; 52/596; 425/111

(57) ABSTRACT

A siding member having longitudinally-oriented reinforcement fibers material extending substantially the entire length of the member contained therein, and an optional meshed reinforcement material contained therein and/or an optional foam insert at least partially enveloped by a cementitious shell. The siding member is molded from cementitious slurry, including gypsum cement and a latex/water mixture, or a hydraulic cement. An amount of the slurry is added onto a bottom mold surface portion to a desired depth and/or weight, along with the longitudinally-oriented reinforcement fibers and the optional meshed reinforcement material and/or any optional foam insert. After sufficient curing, the siding member is removed from the mold and is ready for immediate use and/or further processing. Alternatively, a continuous method is also provided for producing relatively long lengths of the siding that can be cut to an appropriate size, without the need to produce individual siding members of limited size.

### CROSS-REFERENCE TO RELATED APPLICATION

This application claims priority to U.S. Provisional Application Ser. No. 61/145,592, filed on Jan. 19, 2009 (Attorney Docket No. 068002.00801), which is hereby incorporated by reference in its entirety.

### FIELD OF THE INVENTION

The present invention relates generally to siding systems, and more specifically to siding systems formed from cementitious slurries, especially those containing gypsum.

### BACKGROUND OF THE INVENTION

Many homes in North America use brick, vinyl siding, aluminum siding, or wood as the material comprising the exterior walls thereof. Brick provides excellent aesthetic, weather protection, and insulation properties, and is virtually maintenance free. However, brick is considerably more expensive to install than the other three primary siding materials due to the high labor costs.

Vinyl siding is made from PVC (polyvinyl chloride) and has begun to be used in construction more and more all the time. Vinyl siding can be fashioned to resemble wood, with the average width of vinyl siding ranging from 6 inches to 10 inches. However, other various lengths and widths are available. Scratches are rarely visible, because the PVC that the siding is composed of is solid all the way through. Vinyl siding is similar in many properties to aluminum, such as weight and density. However, unlike aluminum, vinyl does not dent, and besides aesthetic repair, scratched vinyl siding does not rust and will not ruin the integrity of the siding. Temperature will not affect vinyl siding, which can be installed in nearly any climate. Aluminum siding might take a long time to re-install if damaged, which is untrue of vinyl siding. Vinyl's temperature at which it ignites is very high (736° F.), and it has half the burn time of cedar and burns one third as hard.

Aluminum siding is also one of the most popular exterior home coverings. It is more common than steel siding systems because steel tends to rust when exposed for a long period of time, unlike aluminum. Like vinyl siding, aluminum siding is relatively low-maintenance in its first few years. Aluminum siding comes in long panels, so it takes less time to install. It has baked on enamel that can be flat or shaped to resemble wood grain. Aluminum siding is waterproof, a good insulator, and the most fireproof type of siding. Unfortunately, aluminum siding is susceptible to dents and can be difficult to repair once it's been completely installed. For the first few years, aluminum siding requires little maintenance. However, it soon may show signs of cracking, corrosion, and peeling. After two or three years, the home owner should begin monitoring the aluminum siding for dents and other marks. Eventually, damaged panels should be repainted or replaced, which is a time-consuming and potentially expensive process.

The most common type of siding for a house is wood (e.g., cypress, cedar, redwood, and/or the like) which provides an attractive appearance and good insulation properties. However, as evidenced by the fact that more and more consumers are choosing vinyl, aluminum, and other siding choices, there are a number of drawbacks.

Wood in general is a haven for animals and insects. For example, many woodpeckers and other birds are drawn to the wood on the outside of houses. It is thought that tannin, a resin that is found in cedar is a natural insect repellent. However, the same tannin can cause rain spots that will appear for the first three years that the cedar is on the home. Redwood is much like cedar except that its color is slightly different.

Plywood, which is a common type of siding, is usually composed of western red fir, yellow pine, and Douglas fir. Either roughhewn or smooth, plywood is usually attached to a home horizontally and isn't the best way to protect from water damage. However, plywood is attractive for its natural look, and many ways are being developed to strengthen its structural integrity. Clapboard is simply long boards of wood applied horizontally and overlapping on a house. The result can look uneven and irregular, but beveled or tapered boards can correct this problem. Hardboard or composition board is comprised of compressed wood fiber and adhesives that are weather resistant and applied to planks or sheets of wood to strengthen them and make them more waterproof. Hardboard can measure 16 feet in length, though many people have it cut to better resemble clapboard. Plywood siding is comprised of a veneer, which is a slice of wood of constant thickness, and it is applied to hardwood to form hardwood siding. More durable than indoor plywood, it is also much more waterproof. Rectangular plank siding is comprised of smooth planks that meet each other evenly. When laid vertically, they form a flat surface that is interrupted only by battens designed to keep moisture out. Wood plank siding is very much like rectangular plank siding in that boards are laid vertically and protected from water damage. However, wood plank siding comes in many shapes and can be cut many different ways to give texture and a pattern.

A rustic, pastoral look can be achieved by using shake siding, which is made up of hand-split, irregular cedar sidings. They are rough and either put on all at once or in layers to use weathering as an effect for patterns. They are susceptible to cracking, warping and curling, so they should be checked often and replaced when necessary. Unlike shakes, sidings are machine cut, smooth and uniform. They are increasingly overlapped as they are higher on the house, however many people create their own patterns and decide the degree to which there is an overlap Like shakes, sidings can fall victim to warping, cracking, and curling.

Any wood siding product, but especially less protected wood like shakes and sidings, should be kept away from moisture and protected from the elements. Typically this involves the regular application of stains, sealants, and paints, and is generally an expensive and time-consuming process. Failure to properly maintain the wood siding product can lead to irreparable damage and potential rotting of the wood, necessitating expensive repairs.

A recent product in the siding market has been asbestos-free fiber-cement siding. Its market share is on the rise, but it still lags behind wood and vinyl siding. Fiber-cement siding generally is more expensive than aluminum or vinyl siding, but it costs less than brick or traditional cedar siding. It is sold under a number of brand names, including HARDIPLANK, CEMPLANK, and WEATHERBOARDS. To make the siding, manufacturers mix cement, sand and cellulose fibers with water. The planks are offered in various widths in both horizontal and vertical styles. They can be given a smooth look or finished with a heavier wood grain appearance. James Hardie Building Products, which makes the HARDIPLANK line, has introduced a plank that simulates the look of sidings to use as an accent on a home. A big selling point is that fiber-cement siding offers a number of benefits over wood. For example, this siding resists damage from the elements and insects, and provides very good structural strength and good impact resistance. From a safety standpoint, the fiber-cement siding itself won't burn, but the finishing materials (e.g., paints) applied thereto might. Although makers of the fiber-cement siding tout its low-maintenance qualities, it does, as noted, need to be painted periodically. Attaching fiber-cement siding to a home is similar to applying wood siding; however, this type of siding is heavier, more difficult to cut, and generally more difficult to install than traditional siding materials.

Another recent development in siding products is molded reinforced cementitious siding. Such siding is comprised of cement, or a cementitious exterior shell at least partially enveloping an optional foam core, wherein the cementitious materials especially contain gypsum (e.g., calcined gypsum). The siding system is formed in a substantially open mold from cementitious slurry comprising gypsum cement (e.g., calcined gypsum) and a latex/water mixture. The slurry can also contain other materials, such as but not limited to reinforcement materials (e.g., fibers, scrims, netting, meshes, and/or the like), as well as other materials that are known in the art (e.g., activators, set preventers, plasticizers, fillers, and/or the like), which can be added before and/or after the combination of the gypsum and latex/water mixture. The slurry is poured into the mold over a previously-inserted meshed reinforcement material, such as a fiberglass mat. The slurry impregnates and envelops the mat, which adds considerable flexibility to the resulting product without it breaking, as would occur in a product formed only of the hardened slurry, even with the inclusion of aggregate reinforcement materials contained in the slurry. Even with the flexing capabilities afforded with meshed or matted reinforcement materials, such siding members can be difficult to handle in long lengths (e.g., of several feet in length), which are typically used in many siding applications where wood siding is simulated.

This is in part due to a lack of member rigidity, which is overcome in part by the inclusion of a foam core. But another factor contributing to this handling problem stems from supporting elongate cementitious members at perhaps only one or two localized positions along its length, which can impart significant bending stresses in the cementitious material, at or between the localized support location(s), where bending is greatest. The bending moment acting on a member at these high stress sites typically result from the member being supported only at or near the midpoint of its length, or being supported only at or near its opposite ends. This is particularly problematic when the planar member is supported in a substantially horizontal orientation.

Therefore, it would be advantageous to provide durable and economical siding systems, and methods for forming the same, which overcome at least one of the aforementioned problems.

### SUMMARY OF THE INVENTION

The present invention provides a siding member, and methods for forming the same, comprised of a cement, or cementitious exterior shell at least partially enveloping an optional foam core, wherein the cementitious materials contain gypsum (e.g., calcined gypsum) or a hydraulic cement. The siding member is formed in a substantially open mold from cementitious slurry comprising gypsum cement (e.g., calcined gypsum) and a latex/water mixture, or comprising a hydraulic cement. The slurry can also contain other materials, such as but not limited to reinforcement materials (e.g., fibers, scrims, netting, meshes, and/or the like), as well as other materials that are known in the art (e.g., activators, set preventers, plasticizers, fillers, and/or the like), which can be added before and/or after the combination of the gypsum and latex/water mixture, or mixing of the hydraulic cement.

The molded siding includes at least one, and preferably a plurality of longitudinally-oriented reinforcement fibers, or bundles of individual reinforcement fibers, that extend substantially the entire length of each molded siding member. The fibers are immersed in the slurry and, once the slurry cures or hardens, are captured by the cementitious material and substantially prevented from moving relative thereto. The fibers may be tensionally prestressed such that in the resulting siding member, the fibers are under tension in the siding member's natural, undeformed state.

Alternatively, the fibers may be subjected to tensile stresses only upon bending deformation of (or tension forces being exerted on) the siding member. The tensioned fibers aid in resisting bending deformation of the siding member, and places the siding member in a longitudinally directed compression, thereby reinforcing it against cracking or breaking, much as steel rebar does in reinforced concrete structures.

With respect to one production process embodiment, an appropriate amount of the cementitious slurry is added onto a bottom mold surface portion to a desired depth. The slurry can contain colorants dispersed therethrough, or alternatively, the bottom mold surface can be coated with a colorant. A reinforcement material (e.g., fibers, scrims, netting, meshes, and/or the like) can be added to the mold either before or after introduction of the cementitious slurry. The longitudinally-oriented reinforcement fibers are added to the mold before or after introduction of the cementitious slurry. Preferably, the longitudinally-oriented reinforcement fibers are maintained under a tension during molding and the hardening or curing phase so that there is no slack in the fibers. Optionally, the fibers may also be pretensioned. After introduction of the cementitious slurry to the mold, an optional foam core can be placed atop the slurry in a desired orientation. An additional amount of the cementitious slurry can then be added on top of the foam core so as to at least partially encapsulate the foam insert. Alternatively, the optional foam core could be left exposed. An optional top mold surface can be employed to ensure that the foam core does not float out of the cementitious slurry. During one or more of the aforementioned stages, the mold can be vibrated and force/pressure applied. After an appropriate curing or drying time, the product (e.g., a molded siding member) is removed from the mold and is ready for immediate use and/or further processing.

The present invention also provides a siding system including at least one elongate member molded of cementitious material, the member including at least one longitudinally-oriented reinforcement fiber that extends substantially the entire length of the member, the fiber having substantially no slack therein along the length of the member and being enveloped by and fixed to the cementitious material. The fiber is subjected to tensile stresses at least during bending deformation of the member, and the bending deformation of the member is resisted by the tensioned fiber.

The reinforcement fiber may be an individual reinforcement fiber or a bundled plurality of individual reinforcement fibers. The member may also include a plurality of reinforcement fibers that are spaced from each other and lying substantially in a plane. Adjacent ones of the plurality of reinforcement fibers may be spaced about ⅛ inch from each other. The reinforcement fiber may be bonded to the cementitious material that envelops it, and may be tensionally pre-stressed, with the member in longitudinally directed compression in its natural, undeformed state.

The member has a front exterior surface and may include a meshed reinforcement material enveloped by the cementitious material, with the meshed reinforcement material disposed between the front exterior surface and the reinforcement fiber. The front exterior surface may define a textured pattern.

The member may include a foam core at least partially encapsulated by cementitious material, with foam core and the front exterior surface located on opposite sides of the reinforcement fiber.

The present invention also provides a molding system for forming an elongate siding member comprising a cementitious material that surrounds and is fixed to at least one reinforcement fiber extending substantially the entire length of the siding member. The molding system includes a mold face defining at least a portion of a front exterior surface of the siding member, means for orienting the reinforcement fiber relative to the mold face and tensioning the reinforcement fiber to at least an extent that the reinforcement fiber has no slack along at least a portion of it that superposes the mold face, and a cementitious material source from which a desired amount of cementitious material is received onto the mold face to envelop the reinforcement fiber.

The cementitious material source may be that from which a desired amount of cementitious material is received onto the mold face to envelop a meshed reinforcement material optionally disposed between the reinforcement fiber and the mold face. The molding system may also include a cementitious material source from which a desired amount of cementitious material is received onto an optional foam core positioned in cementitious material received onto the mold face, with the foam core and mold face located on opposite sides of the reinforcement fiber. The cementitious material sources from which cementitious material is respectively received onto the mold face and onto the foam core may be a common cementitious material source.

The reinforcement fiber may be longitudinally oriented along the length of the elongate siding member through the means for orienting and tensioning the reinforcement fiber.

One embodiment of the molding system provides a mold retainer support having a cavity and a mold surface member, with the mold surface member disposed in the cavity and defining the mold face.

An alternative embodiment of the molding system provides a continuously moving mold face and produces relatively long lengths of the reinforced siding that can be cut to an appropriate size, without the need to produce individual siding members of limited size. Such an embodiment may include a reinforcement fiber feed roller system from which a continuous length of the reinforcement fiber is received over the mold face, and a bottom roller system including the mold face, the mold face having continuous movement in a direction corresponding to the length of the siding member, with the reinforcement fiber feed roller system arranged such that reinforcement fiber received therefrom is positioned relative to the mold face and moved with cementitious material on the mold face. The molding system's cementitious material source may be positioned upstream of the reinforcement fiber feed roller system. The bottom roller system may include an endless belt on which is defined the mold face, and the molding system may include a top roller system comprising an endless belt having continuous movement and superposing the endless belt of the bottom roller system. The molding system may have a path between the superposed belts along which siding member product is moved longitudinally through the molding system.

The molding system may also include a meshed reinforcement feed roller system from which a continuous length of meshed reinforcement material is received over the mold face, with the meshed reinforcement feed roller system arranged such that meshed reinforcement material received therefrom is positioned relative to the mold face and moved with cementitious material on the mold face. A reinforcement fiber feed roller system may be arranged to position reinforcement fiber received therefrom over the meshed reinforcement material. Relative to the direction of mold face movement the cementitious material source may be positioned downstream of the meshed reinforcement feed roller system.

The molding system may also include a foam core feed roller system from which a continuous length of foam core material is received, the foam core feed roller system arranged such that foam core material received therefrom is positioned relative to the mold face and moved with cementitious material on the mold face. The foam core feed roller system may be arranged to position foam core material received therefrom over the reinforcement fiber. Relative to the direction of movement of the mold face the cementitious material source may be positioned upstream of the foam core feed roller system.

The molding system may include a meshed reinforcement feed roller system from which a continuous length of meshed reinforcement material is received and/or a foam core feed roller system from which a continuous length of foam core material is received, with the meshed reinforcement feed roller system and/or the foam core feed roller system respectively arranged such that meshed reinforcement material and/or foam core material respectively received therefrom is positioned relative to the mold face and moved with cementitious material on the mold face. Embodiments of the molding system that include both of the meshed reinforcement feed roller system and the foam core feed roller system, the reinforcement fiber feed roller system may be located therebetween. Relative to the direction of movement of the mold face the top roller system may be located downstream of each feed roller system. The molding system may further include a cutting device by which cured molded siding member product once separated from the mold face is cut to a desired length.

The present invention also provides method of molding an elongate siding member comprising cementitious material and at least one reinforcement fiber that is enveloped and fixed to the cementitious material and which extends substantially the entire length of the siding member. The method includes the steps of: longitudinally-orienting at least one reinforcement fiber over a mold face; tensioning the reinforcement fiber at least to an extent that it has no slack along at least a portion of it that superposes the mold face; receiving cementitious material onto the mold face; enveloping the reinforcement fiber with the cementitious material received onto the mold face; forming a front exterior surface of the siding member from the cementitious material received onto the mold face; curing the formed cementitious material and fixing the tensioned reinforcement fiber to the cementitious material that envelopes it; and separating the siding member and the mold face.

The method may also include the step of elastically deforming the reinforcement fiber until the formed cementitious material is sufficiently cured, such that tension in the reinforcement fiber and longitudinal compression in the cementitious material of the siding member are maintained while the siding member is in a natural, undeformed state.

The method may also include the steps of: introducing a meshed reinforcement material over the mold face; and enveloping the meshed reinforcement material with the cementitious material received onto the mold face.

The method may also include the step of positioning foam core material in the cementitious material received onto the mold face.

The method may also include the step of imparting a pattern into the cementitious material received onto the mold face with the mold face.

The present invention provides an open molding method, and an alternative continuous molding method for producing relatively long lengths of the reinforced siding that can be cut to an appropriate size without the need to produce individual siding members of limited size.

Further areas of applicability of the present invention will become apparent from the detailed description provided hereinafter. It should be understood that the detailed description and specific examples, while indicating the preferred embodiment of the invention, are intended for purposed of illustration only and are not intended to limit the scope of the invention.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is an elevational view of a dwelling having a cementitious siding system, in accordance with a first embodiment of the present invention;

FIG. 1A is a partial perspective view of a dwelling having an alternative design cementitious siding system, in accordance with a second embodiment of the present invention;

FIG. 2 is a perspective view of a cementitious siding member, in accordance with a third embodiment of the present invention, the ends of the longitudinally oriented reinforcement fibers shown untrimmed;

FIG. 2A is a perspective view of an alternative design cementitious siding member, in accordance with a fourth embodiment of the present invention, the ends of the longitudinally oriented reinforcement fibers shown untrimmed;

FIG. 3 is a perspective view of a portion of a molding system for forming a cementitious siding member, in accordance with a fifth embodiment of the present invention;

FIG. 3A is a perspective view of a portion of a molding system for forming an alternative design cementitious siding system, in accordance with a sixth embodiment of the present invention;

FIG. 4 is an exploded view of a mold surface member and the bottom molding member, in accordance with a seventh embodiment of the present invention;

FIG. 5 is a perspective view of the bottom molding member on a conveyor system, in accordance with an eighth embodiment of the present invention;

FIG. 6 is an exploded view of the mold surface member and the bottom molding member on the conveyor system, in accordance with a ninth embodiment of the present invention;

FIG. 7 is an exploded view of a meshed reinforcement material being placed into the mold surface member, in accordance with a tenth embodiment of the present invention;

FIG. 8 is an exploded view of a plurality of longitudinally-oriented reinforcement fibers placed into the mold surface member, with mold inserts also being inserted, in accordance with an eleventh embodiment of the present invention;

FIG. 9 is a perspective view of a cementitious slurry being added onto the tensioned longitudinally-oriented reinforcement fibers, the meshed reinforcement material and the mold surface member, in accordance with a twelfth embodiment of the present invention;

FIG. 10 is an exploded view of an optional foam core material being placed into the cementitious slurry, in accordance with a thirteenth embodiment of the present invention;

FIG. 11 is a perspective view of the optional foam core material placed into the cementitious slurry, in accordance with a fourteenth embodiment of the present invention;

FIG. 12 is an exploded view of the mold surface member containing the formed cementitious siding member being removed from the bottom molding member, in accordance with a fifteenth embodiment of the present invention;

FIG. 13 is an exploded view of the finished cementitious siding member being removed from the mold surface member, prior to trimming the ends of the longitudinally-oriented reinforcement fibers, in accordance with a sixteenth embodiment of the present invention;

FIG. 14 is a schematic view of a first alternative system for producing the cementitious siding members of the present invention, in accordance with a seventeenth embodiment of the present invention;

FIG. 15 is a schematic view of a second alternative system for producing the cementitious siding members of the present invention, in accordance with a eighteenth embodiment of the present invention;

FIG. 16 is a edge-on view of a length of a cementitious siding member of the present invention, supported at the midpoint along its length and allowed to bend under its own weight; and

FIG. 17 is a edge-on view of a length of a cementitious siding member of the prior art, identical to the siding member of FIG. 16 except for excluding longitudinally-oriented reinforcement fibers, supported at the midpoint along its length and allowed to bend under its own weight.

It is to be noted that the Figures are not drawn to scale. In particular, the scale of some of the elements of the Figures is greatly exaggerated to emphasize characteristics of the elements. It is also noted that the Figures are not drawn to the same scale. Elements shown in more than one Figure that may be similarly configured have been indicated using the same reference numerals.

While the invention is susceptible to various modifications and alternative forms, specific embodiments thereof are shown by way of example in the drawings and may herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

The following description of the preferred embodiment(s) is merely exemplary in nature and is in no way intended to limit the invention, or uses. It is to be noted that the Figures are not drawn to scale. In particular, the scale of some of the elements of the Figures is greatly exaggerated to emphasize characteristics of the elements. It is also noted that the Figures are not drawn to the same scale. Elements shown in more than one Figure that may be similarly configured have been indicated using the same reference numerals.

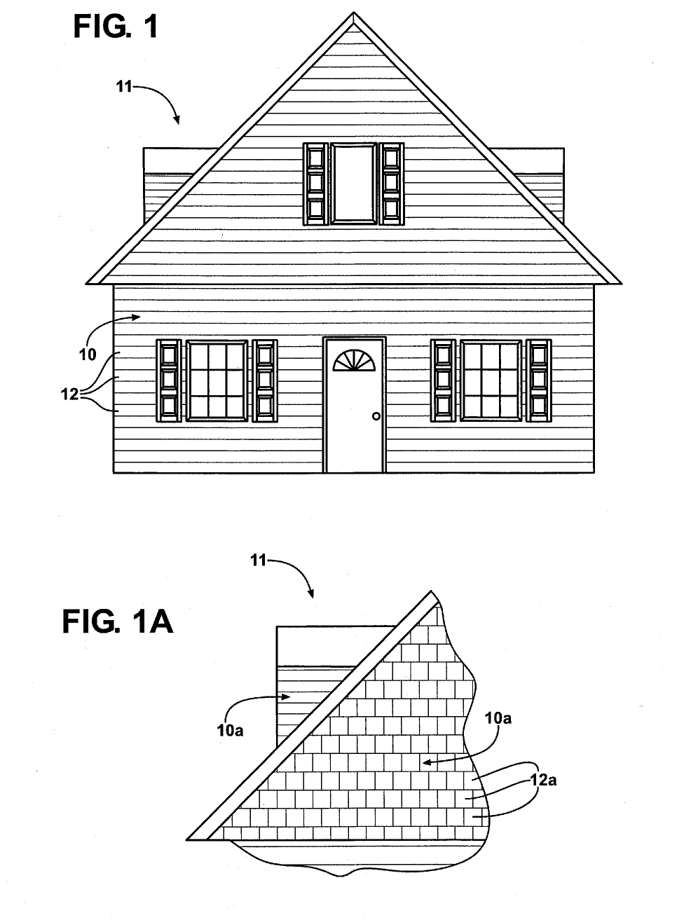

Referring to the Figures generally, and specifically to FIGS. 1 and 1a, a cementitious siding system is generally disclosed at 10. By “system,” as that term is used herein, it is meant at least one siding member 12 or 12a, which may consist of one individually-formed siding member, two integrally formed siding members, and/or a plurality of integrally formed siding members, each siding member 12, 12a being substantially elongate and thereby benefiting most appreciably from the present invention. Although the present invention will be described with primary reference to siding systems or members, it should be appreciated that the present invention can be beneficially practiced with any type of elongate architectural and exterior/interior decorative element, including those having a foam core or insert, regardless of whether the foam core or insert is partially or fully enveloped by a cementitious slurry and/or the like. Further, processes for the manufacture of, for example, cementitious trim members, casing members, roofing members or tiles, and other articles or systems including one or more longitudinally-oriented reinforcement fibers, as well as such articles themselves, are intended to be within the scope of the present invention. Notably, such articles intended to be within the scope of the present invention need not be of a particular form, such as, for example, planar, or even elongate, but rather may be of any configuration benefiting from advantages provided by the present invention.

The siding system 10 can be mounted, either permanently or temporarily to a dwelling, such as a residential or commercial building. FIG. 1 shows an exterior front view of a house 11. The siding systems 10 are rigidly secured to the exteriors walls by appropriate securing devices, such as but not limited to nails, bolts, screws, and/or the like. By way of a non-limiting example, the siding systems 10 can be formed with apertures provided therein for receiving the securing devices.

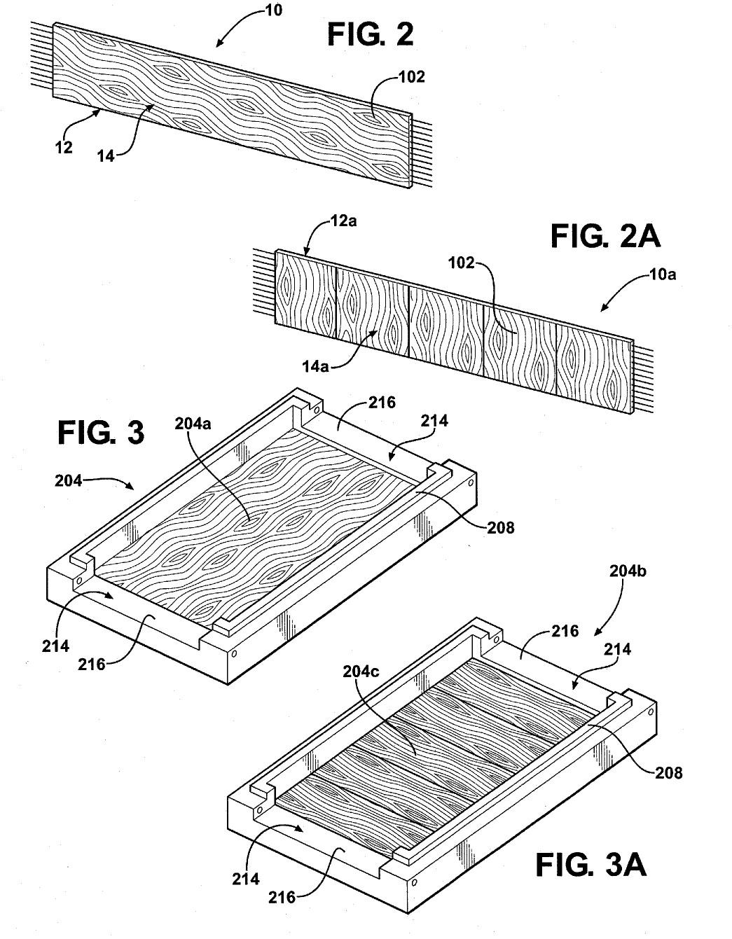

With specific reference to FIGS. 1a and 2a, an alternative design siding system 10a of the present invention can include, without limitation, a “cedar shake” or “cedar shingle” like appearance. In this view, the alternative design siding system 10a includes more than one siding member 12a, formed or placed side by side with one another.

It should be appreciated that the siding members of both siding systems 10, 10a can be cut (e.g., with a circular saw, table saw, tile saw, and/or the like) to desired length, but the provision of longitudinally-oriented reinforcement fibers in members 12, 12a as described below permits their installer and others to more easily handle them in long lengths (i.e., of several feet in length) with substantially reduced risk of the molded cementitious siding members breaking or cracking. As shown, siding systems 10, 10a of the present invention can include surface textures 14, 14a, respectively, to mimic the look of wood grain or any other type of material. Additionally, the siding systems 10, 10a of the present invention can be installed in any number of patterns, e.g., the ground level can include siding system 10 and the second level or eaves can include siding system 10a.

The siding members 12, 12a include at least one, but preferably a plurality of longitudinally-oriented reinforcement fiber bundles extending through substantially the entire member length. The fibers are preferably single continuous strand glass filaments, roved into a bundle having a diameter of approximately 0.020 inch. Such fibers are available from Saint-Gobain Vetrotex of France, and bundles of suitable diameter may culled from a product manufactured thereby having product code RA7035U5. Adjacent fiber bundles are preferably spaced approximately ⅛ inch from each other, and the bundles lie in a plane substantially coinciding with a plane defined by the siding member. In the description that follows, “fiber” or “fibers” shall apply to a fiber individually or a bundle of individual fibers.

The siding members 12, 12a can include a reinforcement material 50, such as but not limited to fibers, scrims, netting, meshes, and/or the like, that can be added during formation or manufacture of the siding members 12, 12a, but are generally referred to as “meshed” reinforcement materials to distinguished them from the longitudinally-oriented reinforcement fibers provided by the present invention. Preferably, the meshed reinforcement material is continuous strand natural fiberglass mat having a weight of approximately 0.75 ounce per square foot.

By way of a non-limiting example, the cementitious slurry is permitted to surround and envelope each of elongate fibers 40, and upon drying or curing, the cementitious material is securely bonded or otherwise fixed to these fibers. Reinforcement fibers 40 impart increased strength that resists bending strain in siding member 12, 12a, markedly improving its ability to substantially maintain its natural, unflexed form when subjected to a bending load about an axis substantially perpendicular to the longitudinally axis of member 12, 12a. The cementitious slurry is also permitted to infiltrate through the various crevices, apertures, or spaces, if present, formed in the meshed reinforcement material 50 such that the meshed reinforcement material 50 is completely surrounded and enveloped by the cementitious slurry. The meshed reinforcement material 50 can aid in imparting increased strength, fracture resistance, and/or flexibility to the siding members 12, 12a.

The siding members 12, 12a can also optionally include a foam insert or core 100 that is completely or at least partially or substantially completely enveloped or surrounded by the cementitious slurry. The foam core 100 can aid in the reduction of the overall weight of the siding members 12, 12a, as well as provide increased rigidity to the siding members 12, 12a. It is to be noted that the cementitious material comprising member 12, 12a beyond that which engages and occupies substantially the same volume meshed reinforcement material 50 tends to crack, craze or otherwise fracture when greatly flexed, which can adversely affect the integrity and appearance of the member. It is therefore preferable, on one hand, to minimize the amount of cementitious material to only that needed to envelope the meshed reinforcement material 50 and fibers 40, and properly define the outwardly facing siding surface. On the other hand, doing this may result in a particularly thin siding member (perhaps undesirably thin from an appearance standpoint) that is very flexible, perhaps too flexible to facilitate its easy handling in long lengths. Incorporating a lightweight foam backing or core to the member structure reduces the amount of cementitious material used for providing a given siding member thickness, reduces the siding member weight by nearly that of the cementitious material it displaces, and provides the elongate siding member with a certain degree of additional rigidity.

In accordance with one aspect of the present invention, a cementitious shell 102 of the siding member 12, 12a is formed from the cementitious slurry. The slurry can include hydraulic cement including, but not limited to, Portland, sorrel, slag, flyash, or calcium alumina cement. Additionally, the cement can include a calcium sulfate alpha hemihydrate or calcium sulfate beta hemihydrate. The slurry can also utilize natural, synthetic, or chemically modified beta gypsum or alpha gypsum cement.

The cementitious slurry preferably includes gypsum cement and a sufficient amount of water added thereto to produce a slurry having the desired consistency, i.e., not too dry nor not too watery. In accordance with one aspect of the present invention, the water is present in combination with a latex material, such that the powdered gypsum material is combined with the latex/water mixture to form the cementitious slurry.

Gypsum is a naturally occurring mineral, calcium sulfate dihydrate, CaSO₄.2H₂O (unless otherwise indicated, hereafter, “gypsum” will refer to the dihydrate form of calcium sulfate). After being mined, the raw gypsum is thermally processed to form a settable calcium sulfate, which can be anhydrous, but more typically is the hemihydrate, CaS₄½H₂O, e.g., calcined gypsum. For the familiar end uses, the settable calcium sulfate reacts with water to solidify by forming the dihydrate (gypsum). The hemihydrate has two recognized morphologies, alpha and beta hemihydrate. These are selected for various applications based on their physical properties. Upon hydration, alpha hemihydrate is characterized by giving rise to rectangular-sided crystals of gypsum, while beta hemihydrate is characterized by hydrating to produce needle-shaped crystals of gypsum, typically with large aspect ratio. In the present invention, either or both of the alpha or beta forms can be used, depending on the mechanical performance required. The beta form generates less dense microstructures and is preferred for low density products. Alpha hemihydrate could be substituted for beta hemihydrate to increase strength and density or they could be combined to adjust the properties.

The cementitious slurry can also include other additives. The additives can include, without limitation, accelerators and set preventers or retarders to control the setting times of the slurry. For example, appropriate amounts of set preventers or retarders can be added to the mixture to increase the shelf life of the resulting slurry so that it does not cure prematurely. When the slurry to be used in molding operations, a suitable amount of an accelerator can be added to the slurry, either before or after the pouring operation, so as to increase the drying and/or curing rate of the slurry. Suitable accelerators include aluminum sulfate, potassium sulfate, and Terra Alba ground gypsum. Additional additives can be used to produce colored siding systems 10, 10a, such as dry powder metallic oxides such as iron and chrome oxide and pre-dispersed pigments used for coloring latex paints.

In accordance with one aspect of the present invention, the cementitious slurry includes a gypsum cement material, such as but not limited to calcined gypsum (e.g., calcium sulfate hemihydrate), also commonly referred to as plaster of Paris. One source of a suitable gypsum cement material is readily commercially available from United States Gypsum Company (Chicago, Ill.) and is sold under the brand name HYDROCAL® FGR 95. According to the manufacturer, HYDROCAL® FGR 95 includes more than 95 wt. % plaster of Paris and less than 5 wt. % crystalline silica.

The gypsum cement material should include an approximate 30% consistency rate. That is, for a 10 lb. amount of gypsum cement material, approximately 3 lbs. of water of would be needed to properly activate the gypsum cement material. If a latex/water mixture is being used to create the cementitious slurry, and the mixture contains approximately 50 wt. % latex solids, then approximately 6 lbs. of the latex/water mixture would be needed, as the latex/water mixture only contains approximately 50 wt. % water, the remainder being the latex solids themselves.

In accordance with another aspect of the present invention, the cementitious slurry includes a melamine resin, e.g., in the dry form, which acts as a moisture resistance agent. The melamine resin is present in an amount of about 10% of the weight of the gypsum cement material. For example, if 10 lbs. of gypsum cement material are used, then approximately 1 lb. of the melamine resin would be used. One source of a suitable melamine resin is readily commercially available from Ball Consulting Ltd. (Ambridge, Pa.).

In accordance with still another aspect of the present invention, the cementitious slurry includes a pH adjuster, such as but not limited to ammonium chloride, a crystalline salt, which acts to ensure proper cross-linking of the latex/water mixture with the dry ingredients, especially the melamine resin. The ammonium chloride is present in an amount of about 1% of the weight of the gypsum cement material. For example, if 10 lbs. of gypsum cement material are used, then approximately 0.1 lbs. of the ammonium chloride would be used. One source of a suitable ammonium chloride is readily commercially available from Ball Consulting Ltd. (Ambridge, Pa.).

In accordance with yet another aspect of the present invention, the cementitious slurry includes a filler such as but not limited to flyash (e.g., cenosphere flyash), which acts to reduce the overall weight and/or density of the slurry. The flyash is present in an amount of about 30% of the weight of the gypsum cement material. For example, if 10 lbs. of gypsum cement material are used, then approximately 3 lbs. of the flyash would be used. One source of a suitable flyash is readily commercially available from Trelleborg Fillite Ltd. (Runcorn, England).

Several of the wet and/or dry components of the cementitious slurry of the present invention are readily commercially available in kit form from the United States Gypsum Company under the brand name REDI-ROCK®. Additional information regarding several suitable components of the cementitious slurry of the present invention can be found in U.S. Pat. No. 6,805,741, the entire specification of which is expressly incorporated herein by reference.

One or more of the dry ingredients are to be combined with the liquid portion of the cementitious slurry, i.e., the latex/water mixture. If the latex/water mixture includes 50 wt. % latex solids, with the rest being water, then the latex/water mixture is present in an amount of about 60% of the weight of the gypsum cement material. For example, if 10 lbs. of gypsum cement material are used, then approximately 6 lbs. of the latex/water mixture would be used. One source of a suitable latex/water mixture is readily commercially available from Ball Consulting Ltd. (Ambridge, Pa.) under the brand name FORTON® VF-812. According to the manufacturer, FORTON® VF-812 is a specially formulated, all acrylic co-polymer (50% solids) which cross links with a dry resin to make the system moisture resistant and UV stable.

The resulting cementitious slurry of the present invention should possess the following attributes: (1) it should stay wet or flowable for as long as possible, e.g., days, weeks, months, as circumstances warrant; (2) it should self level, i.e., the slurry should level by itself without intervention from the user when introduced into or onto a mold face surface; and (3) it should contain a limited water content (e.g., compared to conventional gypsum cement slurries), i.e., it should not be so wet so as to take a very long time (e.g., several hours or even days) to dry or cure.

Alternatively, the cementitious slurry can preferably be a mixture of rapidly setting hydraulic cement that may or may not contain fiberglass fillers. RapidSet Construction Cement, a non-Portland cement manufactured by CTS Cement Manufacturing Corp. of Cypress, Calif. (www.RapidSet.com) is an acceptable alternative to the above-discussed gypsum/latex material, although it is somewhat more brittle and sets in a short time, necessitating its being mixed in rather small batches that can be quickly used. This hydraulic cement is, however, much cheaper than the gypsum/latex mixture, and bonds better to fiberglass.

In accordance with one aspect of the present invention, a reinforcing material can also be disposed within the cementitious slurry, either prior to or after the introduction of the water thereto. The reinforcing material can include, without limitation, fibers, e.g., either chopped or continuous fibers, comprising at least one of polypropylene fibers, polyester fibers, glass fibers, and/or aromatic polyamide fibers. By way of a non-limiting example, the reinforcing material can include a combination of the fibers, such as the polypropylene fibers and the glass fibers or the polyester fibers and the glass fibers or a blend of the polypropylene fibers and the polyester fibers and the glass fibers. If included in the fiber composition, the aromatic polyamide fibers are formed from poly-paraphenylene terephthalamide, which is a nylon-like polymer commercially available as KEVLAR® from DuPont of Wilmington, Del. Of course, aromatic polyamide fibers other than KEVLAR® are suitable for use in the fiber composition of the present invention.

The cementitious slurry can then be mixed, either manually or automatically, so as to adequately combine the various ingredients thereof and optionally can also be agitated, e.g., by a vibrating table, to remove or lessen any air bubbles that formed in the cementitious slurry.

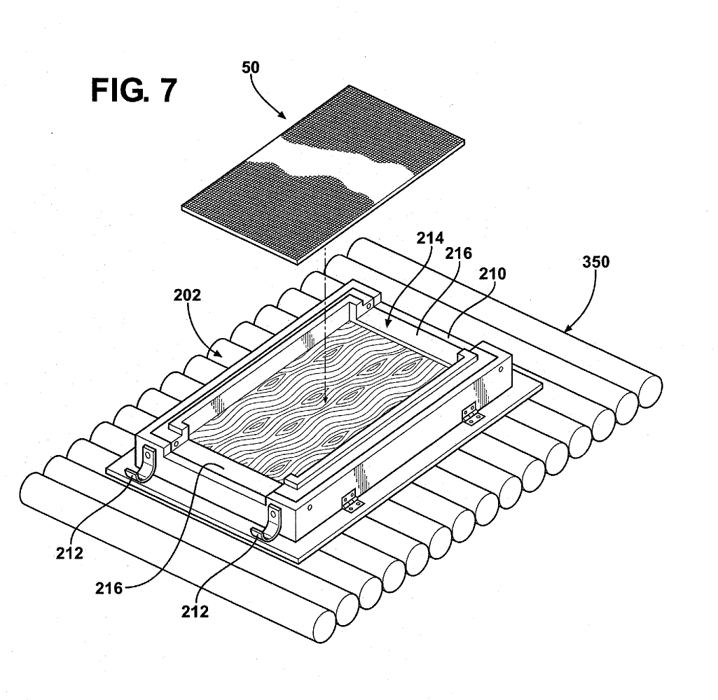

Referring to FIGS. 3-13, one illustrative system and method of forming a siding member 12, 12a of the present invention is shown as a substantially open mold system 200. The depicted mold has a length shown as being much shorter than what may be employed in practice, for elongate member 12, 12a would normally have a length of several feet, and may have a height (or width) of only one foot or less.

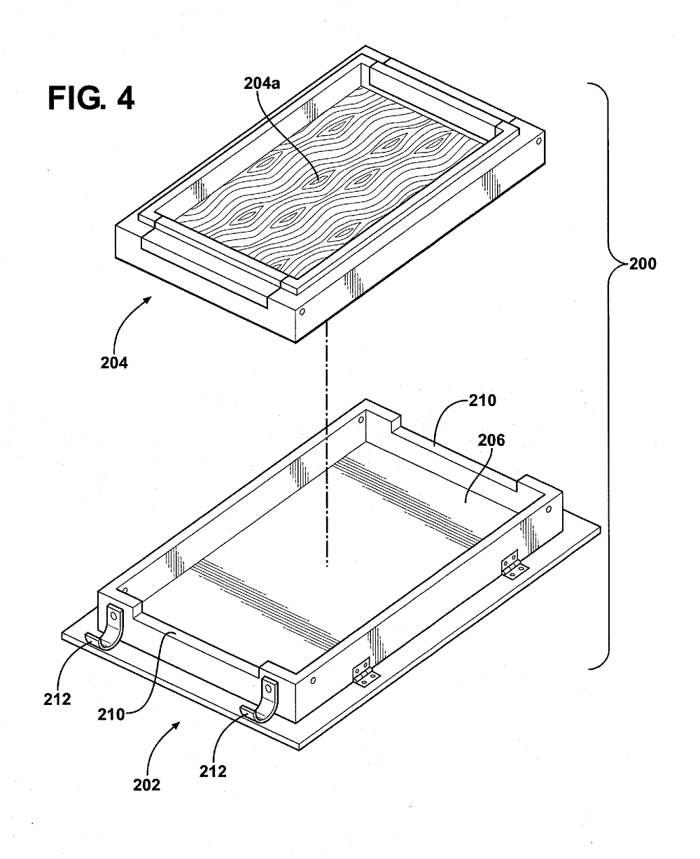

With specific reference to FIGS. 3 and 4, mold system 200 may include a lower or bottom mold retainer support 202, and a mold surface member 204 preferably disposed within a cavity 206 formed in the lower or bottom mold retainer support 202. Although the lower or bottom mold retainer support 202 is shown as being an open shell having a substantially rectangular configuration, the lower or bottom mold retainer support 202 can have any number of various configurations. Lower or bottom mold retainer support 202 may include recesses 210 at its longitudinally opposite ends which accommodate the placement of longitudinally-oriented reinforcement fibers 40 within the mold as described further below.

The mold surface member 204 can be formed of any type of material, such as rigid or flexible materials; however, preferably the mold surface member 204 is formed from a suitably flexible material that, e.g., can be removed from the cavity 206 (e.g., rubber, silicone, urethane and/or the like). The face 204a of the mold surface member 204 is essentially a negative image of the desired front and/or side exterior surface shape of the siding member 12. Additionally, the mold surface member 204 preferably includes a peripheral lip member 208 (FIGS. 3, 3a) to aid in grasping the mold surface member 204, e.g., when it is desired to remove the mold surface member 204 from the cavity 206. Referring specifically to FIG. 3a, an alternative mold surface member 204b is shown for producing siding system 10a, i.e., the face 204c is essentially a negative image of the desired front and/or side exterior surface shape of the siding member 12a. Mold surface member 204, 204b is provided with recesses 214 at its longitudinally-opposite ends, recesses 214 substantially aligning and matching recesses 210 of support 202 when the mold surface member 204, 204b is in cavity 206. The height of bottom surfaces 216 of recesses 214 relative to faces 204a, 204c substantially establish the location in the thickness of members 12, 12a of the plane in which the parallel arrangement of fibers 40 lie. That is to say, the distribution of the plurality of parallel, longitudinally-oriented fibers 40 lie in a plane that, during the molding process, includes surfaces 216.

Although the following description will be directed primarily toward the production of siding member 12, it should be understood that the methodologies disclosed herein are equally applicable to the production of siding member 12a (provided that mold surface member 204b having face 204c is employed).

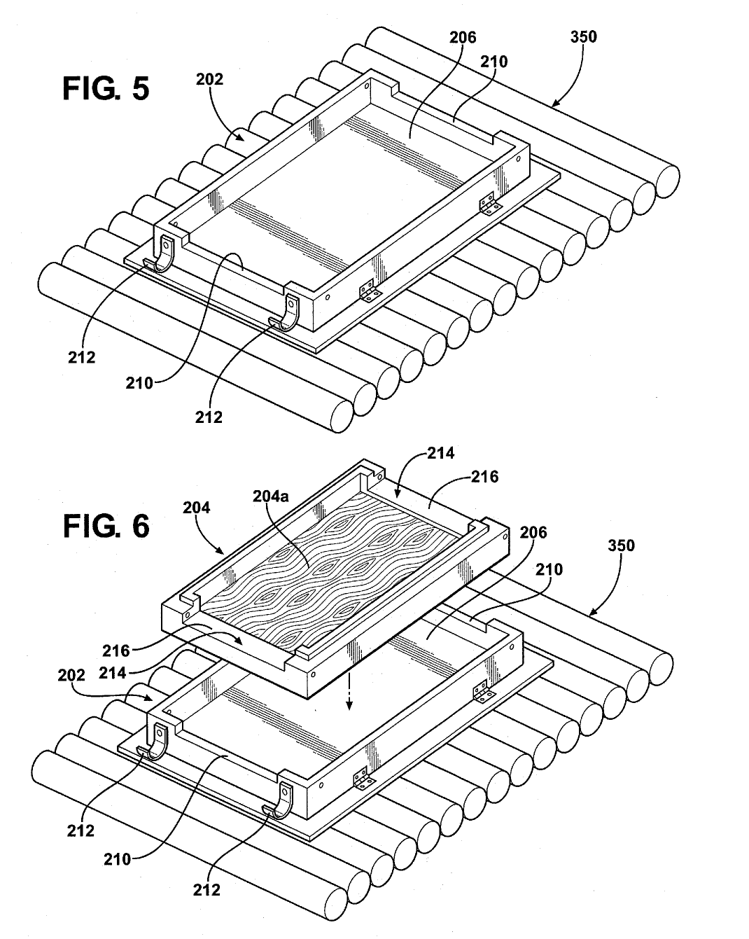

Referring specifically to FIGS. 5 and 6, because of the weights involved of the various components, as well as the cementitious slurry, a transport device, such as a conveyor system 350, either manually or automatically operated, can be employed to guide the mold system 200 along during the manufacturing process, e.g., from an initial processing station, to a curing station, and finally to a product removal station. In this manner, many siding members 12 can be produced sequentially and rapidly (e.g., in an assembly line process) without having to wait for each individual siding system to be finally and completely manufactured.

As previously noted, in order to provide siding member 12 of various colors to satisfy consumer demand, the cementitious slurry can contain colorants dispersed therethrough, or alternatively, the face 204a of the mold surface member 204 can be coated with a colorant, or in the case of a “natural cedar shake” effect, a series of colorants can be provided to produce a multi-colored and/or variegated siding member 12. Furthermore, it should be noted that paints, stains, sealants, and/or the like can also be applied to the face 204a of the mold surface member 204 before the introduction of the cementitious slurry, or alternatively, they can be applied to the finished product after removal from the mold surface member 204. This process can be done in a factory setting or at a worksite, by either the installer or the homeowner.

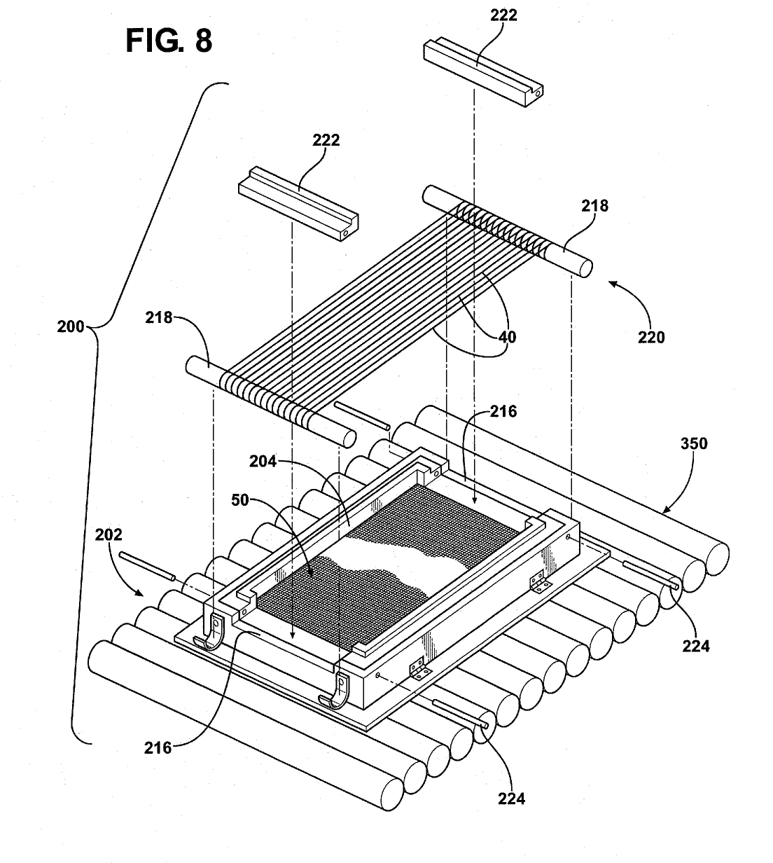

Referring specifically to the embodiment depicted in FIG. 8, with mold surface member 204 having been placed in cavity 206 of support 202, meshed reinforcement material 50 can be optionally, but preferably, placed in the mold surface member 204, and preferably in proximity to the face 204a of the mold surface member 204. Because it is desired that the cementitious slurry be allowed to infiltrate through the meshed reinforcement material 50, it is desirable to leave a space between the meshed reinforcement material 50 and the face 204a of the mold surface member 204 such that the flowing cementitious slurry can fill the area therebetween and prevent any “read through” of the meshed reinforcement material 50 on the finished surface of the siding member 12. A plurality of longitudinally-oriented reinforcement fiber bundles 40, arranged substantially in parallel with each other and spaced about ⅛ inch apart, may be wound about a pair of parallel cylindrical dowels 218, the longitudinal axes of dowels 218 being substantially perpendicular to the directions in which the fibers extend. Fibers 40 extend between and over the uppermost portions of the cylindrical dowel surfaces, and are secured against slippage relative to the dowel surfaces.

Assemblage 220 of dowels 218 and fiber bundles 40 is placed on mold surface member 204, with fibers 40 in close proximity to adjacent meshed reinforcement material 50 if present, and with fibers lying upon and across surfaces 216. Fibers 40 thus extend longitudinally along and completely through the mold surface member 204, and the siding member 12 to be formed therein.

Dowels 218 are secured in retainers or brackets 212 provided on support 202, which maintains the positioning of fibers 40 on surfaces 216 and a tensile stress on fibers 40 sufficient to at least ensure none has slack in it. As discussed above, certain embodiments of the present invention may have or provide for an appreciable amount of tensile prestressing in fibers 40, to elastically stretch them. The assemblage 220 of dowels and fiber bundles 40, and the retainers or brackets 212 provided on support 202, provide system 200 with a means for orienting each of the reinforcement fibers 40 relative to the mold face 204a and tensioning each of the reinforcement fibers 40 to at least an extent that it has no slack along at least a portion of it that superposes mold face 204a.

Mold inserts 222 are then placed in aligned recesses 210 and 214 at the longitudinally opposite ends of the mold, with the plurality of fibers 40 sandwiched between the abutting surfaces of mold inserts 222 and surfaces 216. Mold inserts 222 complete the exterior walls defining the periphery of the mold cavity Mold inserts 222 may be secured in position relative to mold surface member 204 and support 202 with pins 224 that extend through aligned holes in the assembled mold system components. Mold inserts 222 provide sufficient rigidity and structure to support the weight exerted thereon by the cementitious slurry, and may also be coated with a material that provides desired mold release properties (e.g., silicone rubber).

It is to be understood that the above-described mold system including recesses 210, 214, dowels 218, brackets 212 and mold inserts 222, is but one example how longitudinally-oriented reinforcement fibers 40 might be arranged for molding siding member 12. Alternatively, the longitudinally opposite ends of support cavity 206 and/or mold surface member 204 may be provided with a plurality of spaced, vertically-extending slots or holes for accommodating a similar arrangement of fibers 40 that extend through the molded siding member 12 without slack, and with or without providing an appreciable amount of tensile prestressing.

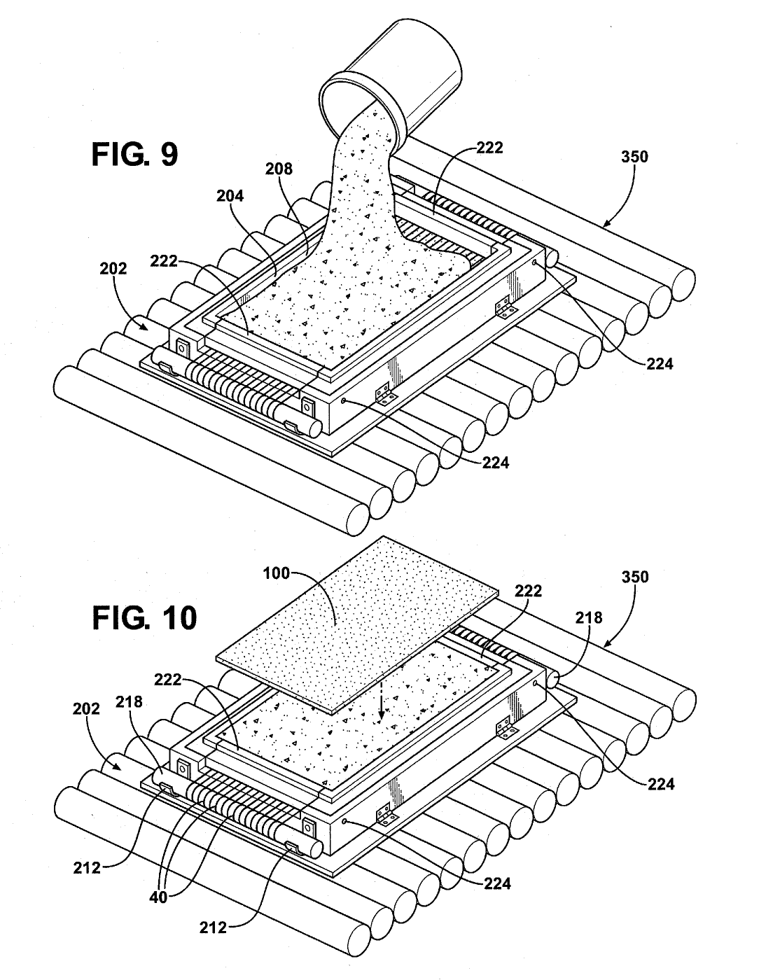

Referring specifically to FIG. 9, after the cementitious slurry has been prepared, as described above, the cementitious slurry, preferably when still wet, is then sprayed or poured either manually or mechanically, into the mold surface member 204 on onto mold face 204a, such that it contacts and fills the mold surface member 204 to a desired depth, enveloping fibers 40 and meshed reinforcement material 50 disposed in the mold cavity. By way of a non-limiting example, the cementitious slurry is poured onto the mold surface member 204 until it reaches a depth of about one-half way up the exterior wall of the mold surface member 204. Alternatively, the amount of the cementitious slurry could be added on the basis of weight, as opposed to volume. However, it should be appreciated that either less than or more than this amount (e.g., volume and/or weight) of the cementitious slurry can be used, e.g., depending on the specific application.

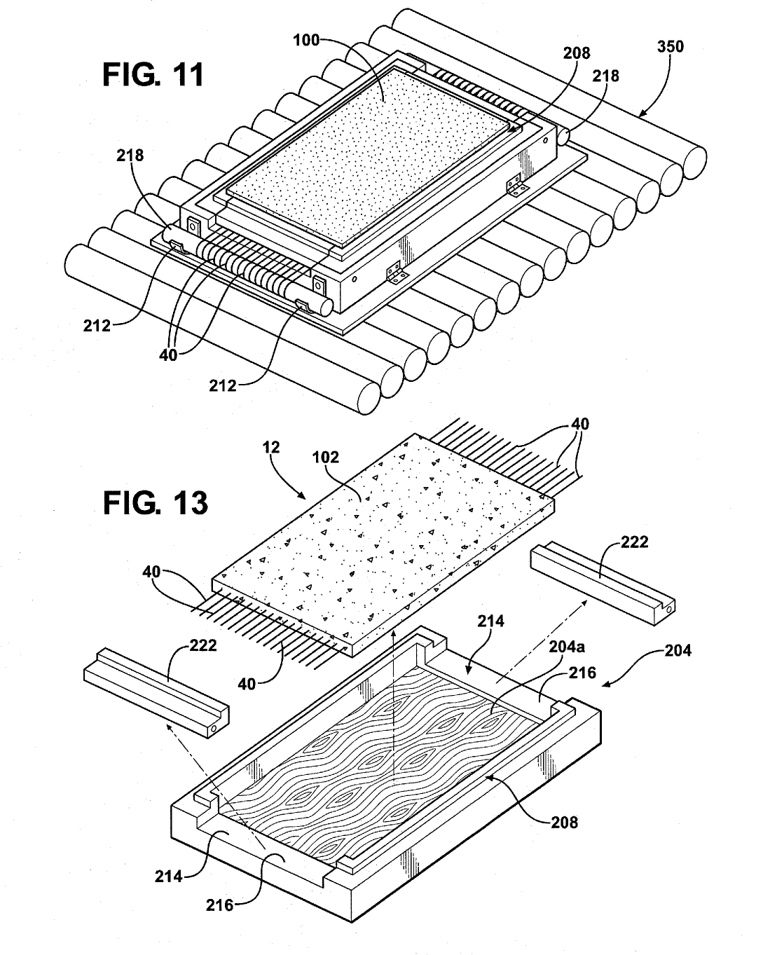

Referring specifically to FIGS. 10 and 11, once a sufficient amount of the cementitious slurry is disposed into the mold surface member 204, the optional foam core or insert 100 is then placed onto the cementitious slurry and is properly positioned in the mold in a desired orientation. At this point, additional amounts of the cementitious slurry is added, preferably on top of the foam core or insert 100 if a fully encapsulated final product is desired, or alternatively, the additional amount of the cementitious slurry is placed around the periphery of the foam core or insert 100 if a partially encapsulated final product is desired. An optional vibratory force can be applied to the mold system 200, e.g., to remove any residual air bubbles in the cementitious slurry, e.g., either before or after the foam core or insert 100 is placed therein.

The cementitious slurry is then allowed to dry, harden or cure for a sufficient amount of time, which may depend, at least in part, on the specific composition of the cementitious slurry used. The mold system 200 can also be shuttled off of the conveyor system 350 and stored in a storage area (not shown) so that other siding systems 10 can be made in the interim.

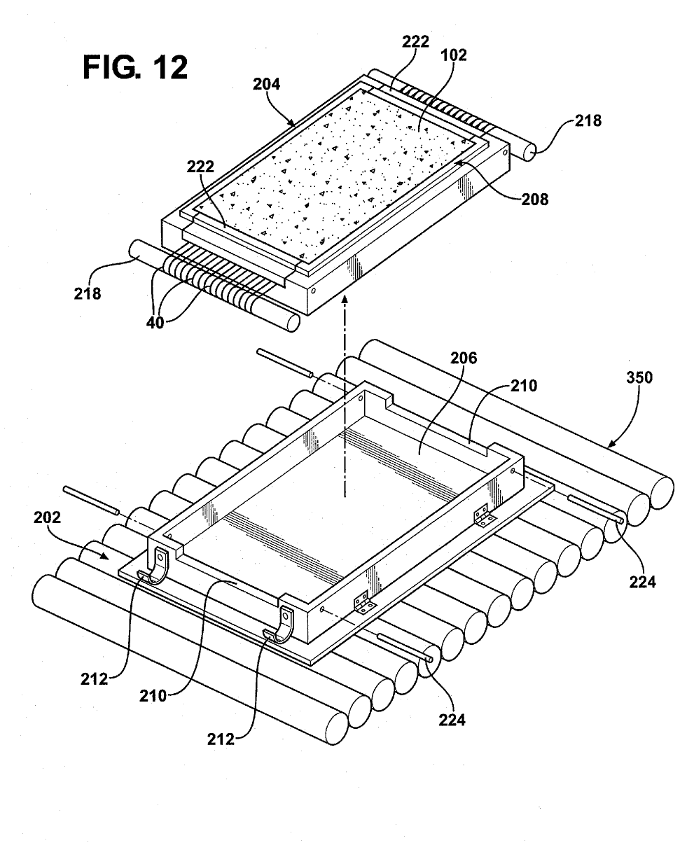

Referring specifically to FIGS. 12 and 13, once the cementitious slurry has dried, hardened or cured, the siding member 12 can then be removed from the mold system 200. For example, mold inserts 222 may be removed, dowels 218 may be released from retainers or brackets 212, and mold surface member 204 may then be removed from the cavity 206 by grabbing the peripheral lip member 208 and lifting the mold surface member 204 upwardly and out of the cavity 206. Fibers 40 are unwound from dowels 218 or cut at the ends of member 12, and the mold surface member 204 is removed from the siding member 12, thus exposing the finished product, which is preferably allowed to dry to a suitable extent, after which time it can then be used immediately or further processed, such as trimming flash or fiber ends as necessary.

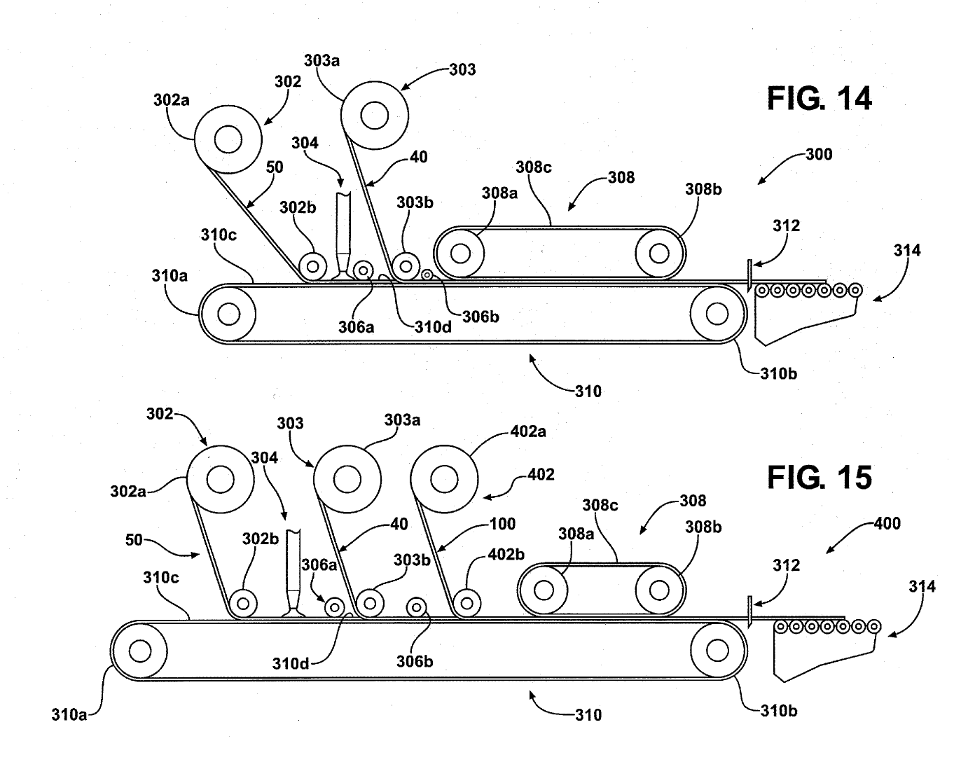

Referring specifically to FIG. 14, there is shown a schematic view of a first alternative system 300 for producing the reinforced cementitious siding of the present invention, i.e., siding members 12, 12a. System 300 provides a continuous method for producing relatively long lengths of the siding that can be cut to an appropriate size, resulting in members 12, 12a, without the need to produce individual siding members of limited size. The system 300 primarily includes a meshed reinforcement feed roller system 302, a longitudinally-oriented reinforcement fiber feed roller system 303, a cementitious slurry feed system 304, first and second slotted rollers 306a and 306b, a top roller system 308 (including rollers 308a and 308b and endless belt 308c) and a bottom roller system 310 (including rollers 310a and 310b and endless belt 310c).

Initially, a continuous length of the meshed reinforcement material 50 is fed via meshed reinforcement feed roller system 302 (including rollers 302a and 302b) onto the exterior surface of endless belt 310c of bottom roller system 310. An appropriate amount of the cementitious slurry is placed onto the reinforcement material 50 via the cementitious slurry feed system 304. The slotted roller 306a (or other appropriate roller or other device) rotates over the cementitious slurry to force the cementitious slurry to infiltrate completely through the meshed reinforcement material 50. Parallel continuous lengths of longitudinally-oriented reinforcement fiber bundles 40, preferably spaced about ⅛ inch apart, are fed via longitudinally-oriented reinforcement fiber feed roller system 303 (including rollers 303a and 303b) onto the exterior surface of endless belt 310c of bottom roller system 310.

Roller 303a may be provided with rotational resistance to provide a desired amount of drag on fibers 40, whereby any slack in fibers 40 is eliminated, and an appreciable amount of tensile prestressing of the fibers 40, if desired, is created. The initial feeding of fibers 40 through system 300 may require providing a pulling force on the fibers' leading ends to take up slack and set the fibers into the molding process. Once the process has begun, however, the cementitious material of the siding product exiting system 300 will have sufficiently cured to capture the fibers being received into system 300, and exert the necessary pulling force on the continuous fiber strands being unwound from roller 303a to eliminate any slack in the fibers 40, or provide tensile prestressing thereof, if desired. The rotational resistance on roller 303a and pulling force exerted on fibers 40 captured within the cementitious material of the exiting siding product provide system 300 with a means for orienting each of the reinforcement fibers 40 relative to the mold face 310d and tensioning each of the reinforcement fibers 40 to at least an extent that it has no slack along at least a portion of it that superposes mold face 310d.

Slotted roller 306b ensures fibers 40 are immersed into and enveloped by the slurry. Notably, slurry feed system 304 could alternatively be located downstream of feed roller system 303, and slotted roller 306a eliminated.

As the cementitious slurry/meshed reinforcement material 50/plurality of longitudinally-oriented reinforcement fibers 40 combination travels through the top roller system 308 and bottom roller system 310, with fibers 40 maintained in tension sufficient to at least prevent any slack therein, the cementitious slurry is contacted by a textured mold face 310d formed on the surface of endless belt 310c of the bottom roller system 310. The textured mold face 310d includes a pattern that is operable to impart the appropriate siding pattern onto the adjacent surface of the cementitious slurry. The finished siding system then passes out through the top roller system 308 and bottom roller system 310 and can be cut by an optional cutting device 312 (e.g., a transverse saw) into siding systems of appropriate length (e.g., “three tab” lengths and/or the like), whereupon the cut siding systems can be fed onto an optional conveyor system 314 for packaging or shipment purposes.

Referring specifically to FIG. 15, there is shown a schematic view of a second alternative system 400 for producing the cementitious siding of the present invention, i.e., siding members 12, 12a. System 400, like system 300, also provides a continuous method for producing relatively long lengths of the siding that can be cut to an appropriate size, resulting in members 12, 12a, without the need to produce individual siding members of limited size. The system 400 is very similar to system 300 depicted in FIG. 14 and/or described above, and likewise includes a meshed reinforcement feed roller system 302, a longitudinally-oriented reinforcement fiber feed roller system 303, a cementitious slurry feed system 304, first and second slotted rollers 306a and 306b, a top roller system 308 (including rollers 308a and 308b and endless belt 308c) and a bottom roller system 310 (including rollers 310a and 310b and endless belt 310c). However, system 400 differs by inclusion of a foam core feed system 402.

As with the system 300 depicted in FIG. 14 and/or described above, a continuous length of the meshed reinforcement material 50 is fed via reinforcement feed roller system 302 (including rollers 302a and 302b) onto the exterior surface of endless belt 310c of bottom roller system 310. An appropriate amount of the cementitious slurry is placed onto the meshed reinforcement material 50 via the cementitious slurry feed system 304. The slotted roller 306a (or other appropriate roller or other device) rotates over the cementitious slurry to force the cementitious slurry to infiltrate completely through the meshed reinforcement material 50. Also as with the system 300 depicted in FIG. 14 and/or described above, parallel continuous lengths of longitudinally-oriented reinforcement fiber bundles 40, preferably spaced about ⅛ inch apart, are fed via longitudinally-oriented reinforcement fiber feed roller system 303 (including rollers 303a and 303b) onto the exterior surface of endless belt 310c of bottom roller system 310. Also as with the system 300 depicted in FIG. 14 and/or described above, roller 303a may be provided with rotational resistance to provide a desired amount of drag on fibers 40, whereby any slack in fibers 40 is eliminated, and an appreciable amount of tensile prestressing of the fibers 40, if desired, is created. Also, as with the system 300 depicted in FIG. 14 and/or described above, the initial feeding of fibers 40 through system 300 may require providing a pulling force on the fibers' leading ends to take up slack and set the fibers into the molding process. Also, as with the system 300 depicted in FIG. 14 and/or described above, once the process has begun, the cementitious material of the siding product exiting system 300 will have sufficiently cured to capture the fibers being received into system 300, and exert the necessary pulling force on the continuous fiber strands being unwound from roller 303a to eliminate any slack in the fibers 40, or provide tensile prestressing thereof, if desired. The rotational resistance on roller 303a and pulling force exerted on fibers 40 captured within the cementitious material of the exiting siding product provide system 400 with a means for orienting each of the reinforcement fibers 40 relative to the mold face 310d and tensioning each of the reinforcement fibers 40 to at least an extent that it has no slack along at least a portion of it that superposes mold face 310d.

Also as with the system 300 depicted in FIG. 14 and/or described above, slotted roller 306b ensures fibers 40 are immersed into and enveloped by the slurry, and slurry feed system 304 could alternatively be located downstream of feed roller system 303, and slotted roller 306a eliminated.

However, in this embodiment, an appropriate length of a foam core material 100 is fed via foam core feed system 402 (including rollers 402a and 402b) onto the “back” surface of the cementitious slurry. As the cementitious slurry/meshed reinforcement material 50/plurality of longitudinally-oriented reinforcement fibers 40/foam core material 100 combination travels through the top roller system 308 and bottom roller system 310, with fibers 40 maintained in tension sufficient to at least prevent any slack therein, the cementitious slurry is contacted by a textured mold face 310d formed on the exterior surface of endless belt 310c of the bottom roller system 310. The textured mold face 310d includes a pattern that is operable to impart the appropriate siding pattern onto the adjacent surface of the cementitious slurry. The finished siding system then passes out through the top roller system 308 and bottom roller system 310 and can be cut by an optional cutting device 312 (e.g., a transverse saw) into siding systems of appropriate length, whereupon the cut siding systems can be fed onto an optional conveyor system 314 for packaging or shipment purposes.

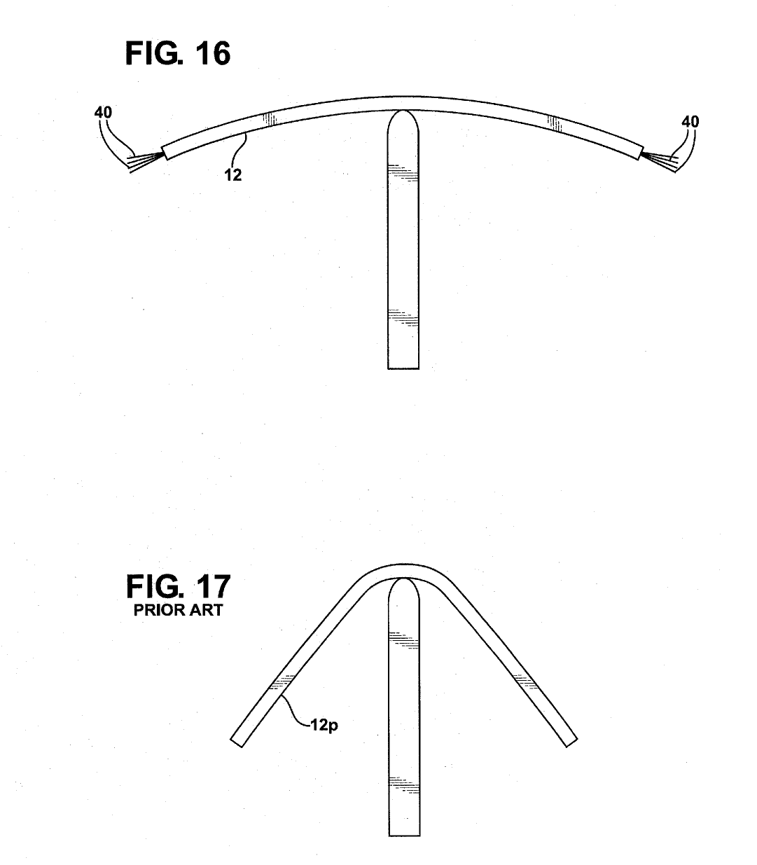

Referring to FIGS. 16 and 17, the effect on bending resistance afforded elongate siding member 12 (FIG. 16) by its being provided with longitudinally-oriented reinforcement fibers 40 in accordance with the present invention, vis-à-vis otherwise identical siding member 12p according to the prior art (FIG. 17), is illustrated. Each of the siding members in FIGS. 16 and 17, exhibits some degree of bending when supported solely at its longitudinal mid-point, but the degree exhibited by siding member 12 of FIG. 16 provided with longitudinally-oriented reinforcement fibers 40 as described above, is markedly less, with the weight of siding member 12 being supported internally by fibers 40 which resist member 12 bending through their supporting tensile stresses, there facilitating easier handling of member 12 with reduced risk of its cementitious material being cracked or broken.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A siding system comprising:
at least one elongate member molded of cementitious material, the member including at least one longitudinally-oriented reinforcement fiber that extends substantially the entire length of the member, the fiber having substantially no slack therein along the length of the member and being enveloped by and fixed to the cementitious material;
wherein the fiber is subjected to tensile stresses at least during bending deformation of the member, and the bending deformation of the member is resisted by the tensioned fiber.

2. The siding system of claim 1, wherein the reinforcement fiber is one of an individual reinforcement fiber and a bundled plurality of individual reinforcement fibers.

3. The siding system of claim 1, wherein the member comprises a plurality of reinforcement fibers, the plurality of reinforcement fibers spaced from each other and lying substantially in a plane.

4. The siding system of claim 3, wherein adjacent ones of the plurality of reinforcement fibers are spaced about ⅛ inch from each other.

5. The siding system of claim 1, wherein the reinforcement fiber is bonded to the cementitious material that envelops it.

6. The siding system of claim 1, wherein the reinforcement fiber is tensionally pre-stressed and the member is in longitudinally directed compression in its natural, undeformed state.

7. The siding system of claim 1, wherein the member has a front exterior surface and comprises a meshed reinforcement material enveloped by the cementitious material, the meshed reinforcement material disposed between the front exterior surface and the reinforcement fiber.

8. The siding system of claim 7, wherein the member front exterior surface defines a textured pattern.

9. The siding system of claim 1, wherein the member comprises a foam core at least partially encapsulated by cementitious material.

10. The siding system of claim 9, wherein the member has a front exterior surface, the foam core and the front exterior surface located on opposite sides of the reinforcement fiber.

11. A molding system for forming an elongate siding member comprising a cementitious material that surrounds and is fixed to at least one reinforcement fiber extending substantially the entire length of the siding member, the system comprising:
a mold face defining at least a portion of a front exterior surface of the siding member;
means for orienting the reinforcement fiber relative to the mold face and tensioning the reinforcement fiber to at least an extent that the reinforcement fiber has no slack along at least a portion of it that superposes the mold face; and
a cementitious material source from which a desired amount of cementitious material is received onto the mold face to envelop the reinforcement fiber.

12. The molding system of claim 11, wherein the cementitious material source is that from which a desired amount of cementitious material is received onto the mold face to envelop a meshed reinforcement material optionally disposed between the reinforcement fiber and the mold face.

13. The molding system of claim 11, further comprising a cementitious material source from which a desired amount of cementitious material is received onto an optional foam core positioned in cementitious material received onto the mold face, the foam core and mold face located on opposite sides of the reinforcement fiber.

14. The molding system of claim 13, wherein the cementitious material sources from which cementitious material is respectively received onto the mold face and onto the foam core comprise a common cementitious material source.

15. The molding system of claim 11, wherein the reinforcement fiber is longitudinally oriented along the length of the elongate siding member through the means for orienting and tensioning the reinforcement fiber.

16. The molding system of claim 11, further comprising a mold retainer support having a cavity and a mold surface member, the mold surface member disposed in the cavity and defining the mold face.

17. The molding system of claim 11, further comprising a reinforcement fiber feed roller system from which a continuous length of the reinforcement fiber is received over the mold face, and a bottom roller system including the mold face, the mold face having continuous movement in a direction corresponding to the length of the siding member, the reinforcement fiber feed roller system arranged such that reinforcement fiber received therefrom is positioned relative to the mold face and moved with cementitious material on the mold face.

18. The molding system of claim 17, wherein the cementitious material source is positioned upstream of the reinforcement fiber feed roller system.

19. The molding system of claim 17, wherein the bottom roller system comprises an endless belt on which is defined the mold face.

20. The molding system of claim 19, further comprising a top roller system comprising an endless belt having continuous movement and superposing the endless belt of the bottom roller system, the molding system having a path between the superposed belts along which siding member product is moved longitudinally through the molding system.

21. The molding system of claim 17, further comprising a meshed reinforcement feed roller system from which a continuous length of meshed reinforcement material is received over the mold face, the meshed reinforcement feed roller system arranged such that meshed reinforcement material received therefrom is positioned relative to the mold face and moved with cementitious material on the mold face.

22. The molding system of claim 21, wherein the reinforcement fiber feed roller system is arranged to position reinforcement fiber received therefrom over the meshed reinforcement material.

23. The molding system of claim 22, wherein relative to the direction of mold face movement the cementitious material source is positioned downstream of the meshed reinforcement feed roller system.

24. The molding system of claim 17, further comprising a foam core feed roller system from which a continuous length of foam core material is received, the foam core feed roller system arranged such that foam core material received therefrom is positioned relative to the mold face and moved with cementitious material on the mold face.

25. The molding system of claim 24, wherein the foam core feed roller system is arranged to position foam core material received therefrom over the reinforcement fiber.

26. The molding system of claim 25, wherein relative to the direction of movement of the mold face the cementitious material source is positioned upstream of the foam core feed roller system.

27. The molding system of claim 20, further comprising at least one of a meshed reinforcement feed roller system from which a continuous length of meshed reinforcement material is received and a foam core feed roller system from which a continuous length of foam core material is received, the meshed reinforcement feed roller system and/or the foam core feed roller system respectively arranged such that meshed reinforcement material and/or foam core material respectively received therefrom is positioned relative to the mold face and moved with cementitious material on the mold face.

28. The molding system of claim 27, wherein the molding system includes both of the meshed reinforcement feed roller system and the foam core feed roller system, with the reinforcement fiber feed roller system located therebetween.

29. The molding system of claim 27, wherein relative to the direction of movement of the mold face the top roller system is located downstream of each feed roller system.

30. The molding system of claim 11, further comprising a cutting device by which cured molded siding member product once separated from the mold face is cut to a desired length.

31. An elongate siding member comprising a cementitious material that surrounds and is fixed to at least one reinforcement fiber extending substantially the entire length of the siding member formed by the molding system of claim 11.

32. The elongate siding member of claim 31, wherein the member includes at least one longitudinally-oriented reinforcement fiber that extends substantially the entire length of the member, the fiber having substantially no slack therein along the length of the member and being enveloped by and fixed to the cementitious material; and
wherein the fiber is subjected to tensile stresses at least during bending deformation of the member, and the bending deformation of the member is resisted by the tensioned fiber.

33. A molding system for forming the siding system of claim 1, the molding system comprising:
a mold face defining at least a portion of a front exterior surface of the siding member;
means for orienting the reinforcement fiber relative to the mold face and tensioning the reinforcement fiber to at least an extent that the reinforcement fiber has no slack along at least a portion of it that superposes the mold face; and
a cementitious material source from which a desired amount of cementitious material is received onto the mold face to envelop the reinforcement fiber.
